(19) United States
(12) Patent Application Publication
(10) Pub. No.: US 2011/0287755 A1
(43) Pub. Date: Nov. 24, 2011

(54) METHOD AND APPARATUS FOR POWER SAVING OF CSG FEMTO BASE STATION IN WIRELESS COMMUNICATION SYSTEM

(75) Inventors: Eun Seon CHO, Daejeon (KR); Chan Yong LEE, Daejeon (KR); Hong Soog KIM, Daejeon (KR); Nam Hoon PARK, Daejeon (KR)

(73) Assignee: Electronics and Telecommunications Research Institute, Daejeon (KR)

(21) Appl. No.: 13/112,270

(22) Filed: May 20, 2011

(30) Foreign Application Priority Data
May 20, 2010 (KR) 10-2010-0047525

(51) Int. Cl. H04W 4/00

(52) U.S. Cl. 455/418

(57) ABSTRACT

Provided are a method and an apparatus for power saving of a CSG femto base station in a wireless communication system. A method of controlling a femto base station according to an exemplary embodiment of the present invention includes: a macro base station to which the femto base station belongs to verify whether or not terminals registered in the femto base station exist in a service coverage of the macro base station, verifying an operation mode of the femto base station if at least one of the registered terminals exists in the service coverage of the macro base station on the basis of the verification result; and allowing the macro base station to direct the switching to an active mode to the femto base station when the femto base station operates in a sleep mode on the basis of the verification result.

### CROSS-REFERENCE TO RELATED APPLICATIONS

This application claims priority under 35 U.S.C. §119 to Korean Patent Application No. 10-2010-0047525, filed on May 20, 2010, in the Korean Intellectual Property Office, the disclosure of which is incorporated herein by reference in its entirety.

### TECHNICAL FIELD

The present invention relates a method and an apparatus for saving power of a femto base station and reducing an amount of interference that occurs due to the operation of the femto base station in a wireless communication system, and more particularly, to a method and an apparatus for switching a femto base station to two modes of a sleep mode and an active mode by using a message through an X2 interface with a macro base station in a wireless communication system.

### BACKGROUND

In a cellular type wireless communication system, a channel condition is deteriorated due to a geographical condition or a distance between a terminal and a base station or the movement of the terminal, such that communication between the terminal and the base station is not smoothly performed. For example, even in a service area of the base station a radio wave shadow area is formed by an enclosed building such as an office or a house. As a result, the wireless communication system provides a femto cell service for providing a high-speed data service while solving a problem in providing a service in the radio wave shadow area.

Since the femto base station a commercial broadband network such as a digital subscriber loop (DSL) or a cable modem installed in the inside as a back hole, the femto base station may be installed by users themselves. In this case, since the femto base station is installed by the users themselves, electric power required by the femto base station should be directly supplied to the home or the office. Further, since a plurality of femto base stations may be positioned in a service area of a macro base station, operating the femto base station may have a negative influence such as interference to terminals of another femto cell or terminals of a macro cell.

Accordingly, the wireless communication system providing the femto cell needs a method for power saving of the femto base station and reducing an amount of interference generated by operating the femto base station.

### SUMMARY

An exemplary embodiment of the present invention provides a method of controlling a femto base station that includes: determining whether or not terminals registered in the femto base station exist in a service coverage of a macro base station to which the femto base station belongs; allowing the macro base station to verify an operation mode of the femto base station if all the terminals registered in the femto base station do not exist in the service coverage of the macro base station on the basis of the determination result; and allowing the macro base station to direct the switching to a sleep mode to the femto base station when the femto base station operates in an active mode on the basis of the verification result.

Another exemplary embodiment of the present invention provides a method of controlling a femto base station that includes: determining whether or not terminals registered in the femto base station exist in a service coverage of a macro base station to which the femto base station belongs; verifying an operation mode of the femto base station if at least one terminal of the registered terminals exists in its own service coverage on the basis of the determination result; and allowing the macro base station to direct the switching to an active mode to the femto base station when the femto base station operates in a sleep mode on the basis of the verification result.

Yet another exemplary embodiment of the present invention provides a macro base station that includes: a position verification unit verifying positions of terminals registered in a femto base station positioned in a macro cell; a position comparison unit comparing a service coverage of the macro base station with the verified positions of the terminals; and a control unit directing the switching of an operation mode of the femto base station in accordance with the comparison result; a transmission unit transmitting mode switching information to the femto base station in accordance with a direction of the control unit, and a memory unit storing list information including identifiers of the terminals registered in the femto base station from the femto base station in accordance with the direction of the control unit.

Still another exemplary embodiment of the present invention provides a femto base station that includes: a reception unit receiving operation mode switching direction information from a macro base station through wireless communication; a control unit controlling the switching of an operation mode in accordance with the direction of the switching of the operation mode received through the reception unit; and a transmission unit transmitting a reply message to the macro base station when the operation mode switching direction information is received.

Other features and aspects will be apparent from the following detailed description, the drawings, and the claims.

### BRIEF DESCRIPTION OF THE DRAWINGS

FIG. 1 is a configuration diagram of a wireless communication system for describing a method for controlling a femto base station according to an exemplary embodiment of the present invention;

FIG. 2 is a diagram illustrating a procedure of setting a sleep-mode operation of a macro base station and a femto base station in a method of controlling a femto base station according to an exemplary embodiment of the present invention;

FIG. 3 is a flowchart illustrating a method of controlling a femto base station in a sleep mode in a method of controlling the base station according to an exemplary embodiment of the present invention;

FIG. 4 is a flowchart illustrating a method of controlling a femto base station in an active mode in a method of controlling the femto base station according to an exemplary embodiment of the present invention;

FIG. 5 is a flowchart illustrating a method of controlling a femto base station in an active mode in a method of controlling the femto base station according to an exemplary embodiment of the present invention;

FIG. 6 is a block diagram illustrating the macro base station according to another exemplary embodiment of the present invention; and

FIG. 7 is a block diagram illustrating a configuration of a femto base station according to yet another exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

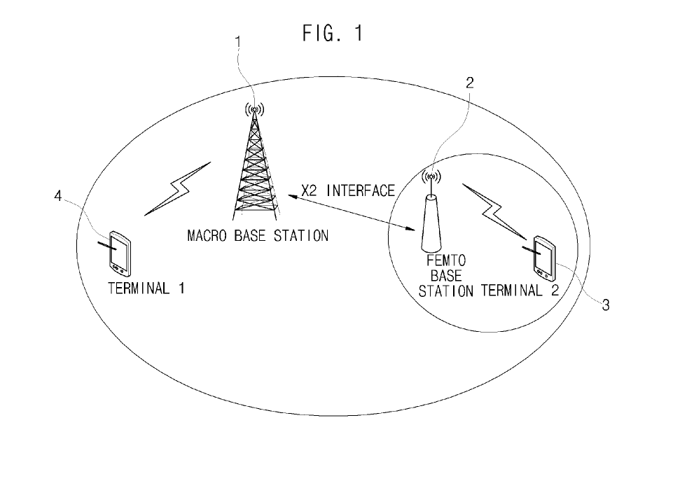

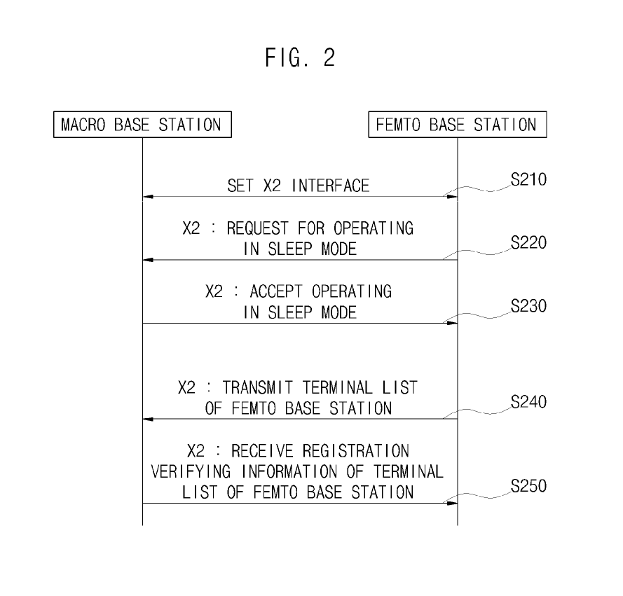

Referring to FIGS. 1 and 2, a method of setting a sleep-mode operation of a macro base station and a femto base station according to an exemplary embodiment of the present invention will be described. FIG. 1 is a configuration diagram of a wireless communication system for describing a method for controlling a femto base station according to an exemplary embodiment of the present invention and FIG. 2 is a diagram illustrating a procedure of setting a sleep-mode operation of a macro base station and a femto base station in a method of controlling a femto base station according to an exemplary embodiment of the present invention.

Referring to FIG. 1, the wireless communication system in which the method of controlling the femto base station according to the exemplary embodiment of the present invention is performed includes a macro base station 1 and one or more femto base stations 2 in service coverage of the macro base station 1. Herein, the macro base station 1 and the femto base station 2 may set up a network interface by setting an X2 interface that serves to exchange a signal for fast handover and information on a load indicator, and information for self-optimization of the operation of a base station between the base stations.

Herein, the femto base station 2 may operate in any one type of an open access femto base station, a close subscriber group (CSG) femto base station, and a hybrid access femto base station depending on limitation of accessible terminals 3 and 4 or not. The open access femto base station represents a base station which is usable by all terminals which subscribe to the corresponding mobile communication service. The closed subscriber group (CSG) femto base station represents a base station which is usable by only terminals designed by the consent of an installer of the femto base station and a mobile communication service provider. The hybrid access femto base station represents a base station supporting both the open access type and the CSG type. That is, the hybrid access femto base station operates as the CSG femto base station with respect to terminals which are accepted to access the femto base station and operates as the open access femto base station with respect to the rest of the terminals. In this case, the hybrid femto base station controls the terminals which are accepted to access the femto base station more preferential than the rest of the terminals.

Further, the hybrid femto base station may limit the amount of wireless resources which are allocatable to terminals which are not accepted to access in order to ensure services of the terminals which are accepted to access the femto base station. In the following description, the femto base station 2 operates as a closed subscriber group cell and it is assumed that only a registered terminal 3 which is accepted to access the femto base station 2 is accessible. However, the present invention is not limited thereto.

Referring to FIG. 2, first, when electric power is applied, the femto base station 2 performs base station self-configuration and thereafter, sets an interface with an adjacent macro base station 1 (S210). The base station self-configuration includes initializing a base station in order to apply the electric power and complete an RF transmission standby state and setting basic information required for operating a system by an automatic installation program.

Specifically, the base station self-configuration as a series of processes performed to interact with the existing system when the base station is firstly turned on includes setting up a network interface, automatically granting a physical ID for a generated cell, and exchanging information for establishing a relationship with neighboring cells. Herein, the set-up of the network interface represents setting an X2 interface which is a network line for direct communication with the macro base station 1 which presently exists on the system.

Next, when the femto base station 2 transmits information regarding a request for the sleep-mode operation to the adjacent macro base station 1 through the X2 interface (S220) and receives information regarding an acceptance of the sleep-mode operation from the macro base station 1 (S230), information on a list of terminals 3 registered in the femto base station 2 is transmitted to the macro base station 1 (S240). The macro base station 1 stores the list information of the terminals 3 registered in the femto base station 2 and thereafter, transmits information regarding the verification of the registration of the terminal list to the femto base station 2 (S250). Herein, information which the femto base station 2 and the macro base station 1 transmit and receive by using the X2 interface may be at least one of a message, a signature, and the like.

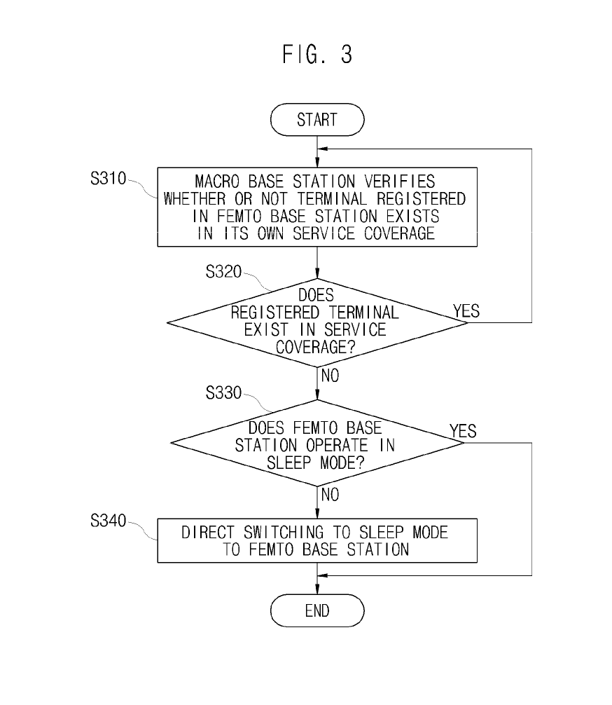

Referring to FIGS. 1 and 3, the method of controlling the femto base station according to the exemplary embodiment of the present invention will be described. FIG. 3 is a flowchart illustrating a method of controlling a femto base station in a sleep mode in a method of controlling the femto base station according to an exemplary embodiment of the present invention.

Referring to FIGS. 1 and 3, first, a macro base station 1 verifies whether or not terminals 3 registered in the femto base station 2 exist in a service coverage of the macro base station 1 (S310).

Next, the macro base station 1 determines whether or not all of the terminals 3 registered in the femto base station 2 exist in the service coverage of the macro base station 1 (S320).

The macro base station 1 may use positional information of the femto base station 2 and positional information of the terminals 3 registered in the femto base station 2.

As one example, the macro base station 1 may receive the positional information from the femto base station 2 and the terminals 3 registered in the femto base station 2 and as another example, the macro base station 1 may measure the positional information of the terminals 3 registered in the femto base station 2. The macro base station 1 may determine whether or not the registered terminals 3 exist in the service coverage of the macro base station 1 by comparing the inputted service coverage of the macro base station 1 with the acquired positional information of the registered terminals 3.

Further, the macro base station 1 determine whether or not the registered terminals 3 accessing the macro base station 1 exist within a predetermined reference time to determine whether or not the registered terminals 3 exist in the service coverage of the macro base station 1.

In addition, the macro base station 1 may receive and store list information including identifiers of the registered terminals 3 from the femto base station 2. If the registered terminals 3 enters the service coverage of the macro base station 1, the macro base station 1 may determine whether or not the registered terminals 3 exist in the service coverage of the macro base station 1 by comparing the identifiers of the registered terminals 3 stored in the macro base station 1 with the identifiers of the registered terminals 3 included in an access verification message.

On the basis of the determination result, if all the terminals 3 registered in the femto base station 2 do not exist in the service coverage of the macro base station 1, the macro base station 1 verifies an operation mode of the femto base station 2 (S330).

On the basis of the verification result, when the femto base station 2 operates in an active mode, the macro base station 1 directs the femto base station 2 to be switched to the sleep mode (S340). Herein, the macro base station 1 may transmit at least one switching direction information of the message, the signature, and the like to the femto base station 2.

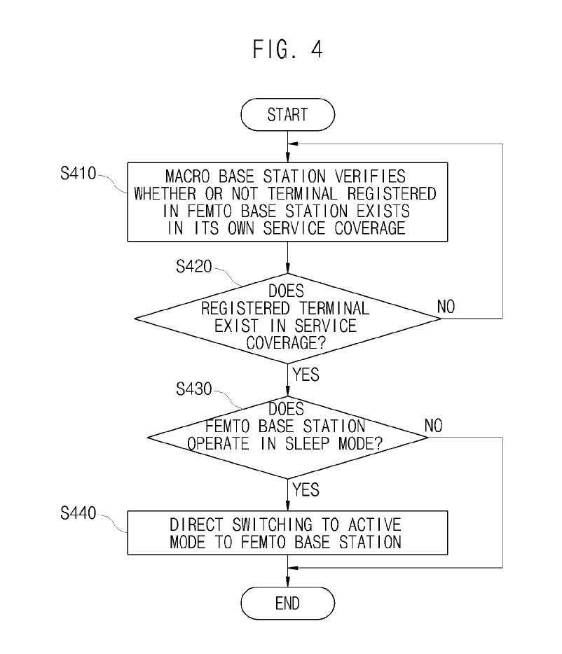

Referring to FIGS. 1 and 4, a method of controlling a femto base station according to another exemplary embodiment of the present invention will be described. FIG. 4 is a flowchart illustrating a method of controlling a femto base station in an active mode in a method of controlling the femto base station according to an exemplary embodiment of the present invention.

Referring to FIGS. 1 and 4, first, the macro base station 1 verifies whether or not the terminals 3 registered in the femto base station 2 exist in the service coverage of the macro base station 1 (S410). As one example, the macro base station 1 verifies the positional information of the terminals 3 registered in the femto base station 2. For example, the macro base station 1 may receive the positional information of the terminals 3 registered in the femto base station 2 through the femto base station 2 and as another example, the macro base station 1 may directly receive the positional information from the registered terminals 3 and as yet another example, the macro base station 1 may measure the positional information of the terminals 3 registered in the femto base station 2.

Next, the macro base station 1 determines whether or not all the terminals 3 registered in the femto base station 2 exist in the service coverage of the macro base station 1 by comparing the positional information of the terminals 3 registered in the femto base station 2 with the positional information of the femto base station 2 (S420).

On the basis of the determination result, if even any one of the terminals 3 registered in the femto base station 2 exists in the service coverage of the macro base station 1, the macro base station 1 verifies the operation mode of the femto base station 2 (S430).

On the basis of the verification result, when the femto base station 2 operates in the sleep mode, the macro base station 1 directs the femto base station 2 to be switched to the active mode (S440). Herein, the macro base station 1 may transmit at least one switching direction information of the message, the signature, and the like to the femto base station 2.

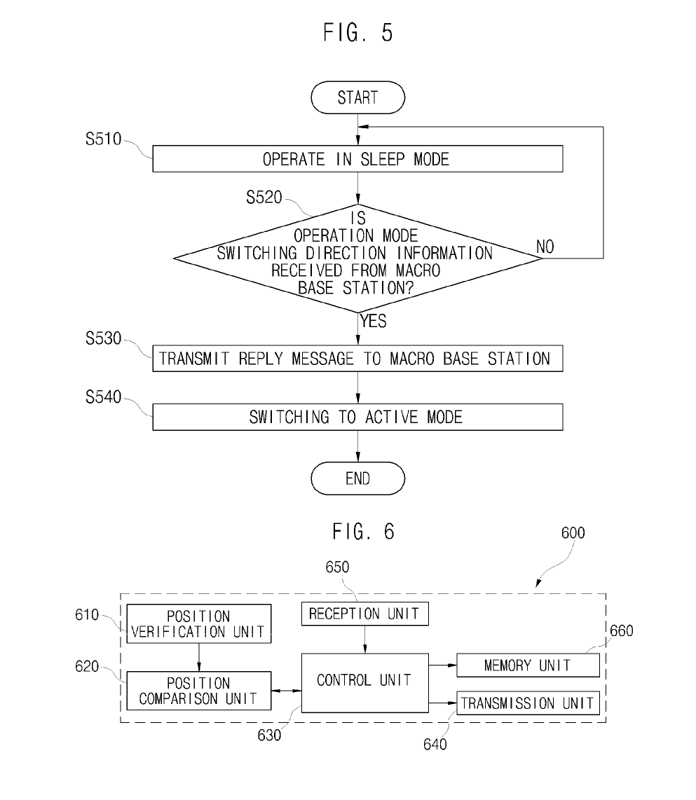

Referring to FIGS. 1 and 5, a procedure of the femto base station for switching the femto base station to the active mode by using the method of controlling the femto base station according to the exemplary embodiment of the present invention will be described. FIG. 5 is a flowchart illustrating a method of controlling a femto base station in an active mode in a method of controlling the femto base station according to an exemplary embodiment of the present invention.

Referring to FIGS. 1 and 5, first, in the case in which the femto base station 2 operates in the sleep mode (S510), when the macro base station 1 transmits at least one switching direction information of the message, the signature, and the like at step S440, the femto base station 2 verifies whether or not mode switching direction information is received from the macro base station 1 (S520).

On the basis of the verification result, when operation mode switching direction information is received from the macro base station 1, the femto base station 2 transmits a reply message to the macro base station 1 (S530) and is switched to the active mode (S540).

Referring to FIG. 6, the macro base station according to another exemplary embodiment of the present invention will be described. FIG. 6 is a block diagram illustrating the macro base station according to another exemplary embodiment of the present invention.

Referring to FIG. 6, the macro base station 600 includes a position verification unit 610, a position comparison unit 620, a control unit 630, a transmission unit 640, a reception unit 650, and a memory unit 660.

The position verification unit 610 provides the positional information of the registered terminals 3 to the position comparison unit 620.

The position comparison unit 620 verifies whether or not a terminal registered in the femto base station is adjacent in the service coverage of the macro base station 600 or whether or not a terminal moves into the service coverage of the macro base station 600 by using the positional information of the terminals registered in the femto base station received from the position verification unit 610 and information of the terminal registered in each femto base station from the memory unit 660.

The control unit 630 controls overall transmission and reception operations of the macro base station 600. Specifically, the control unit 630 controls operation modes of femto base stations which exist in its own cell in accordance with information received from the reception unit 650 and the position comparison unit 620. For example, when an initial access request message of the femto base station is received from the reception unit 650, the control unit 630 provides positional information of the femto base station included in the initial access request message to the memory unit 660 and provides the list information of the terminals registered in the femto base station to the memory unit 660.

Further, the control unit 630 determines whether or not at least one of the terminals registered in the femto base station exists in the service coverage of the macro base station 600 by using information received from the position comparison unit 620. On the basis of the determination result, when at least one terminal of the terminals registered in the femto base station exists in the service coverage of the macro base station 600, the control unit 630 controls to transmit a message to direct the switching to the active mode to the femto base station.

As another exemplary embodiment, the control unit 630 may transmit a message directing mode switching depending on the operation mode of the femto base station. For example, the control unit 630 determines whether or not at least one of the terminals registered in the femto base station exists in the service coverage of the macro base station 600 by using information received from the position comparison unit 620. On the basis of the determination result, when at least one terminal of the terminals registered in the femto base station exists in the service coverage of the macro base station 600, the control unit 630 verifies the operation mode of the femto base station and on the basis of the verification result, when the femto base station operates in the sleep mode, the control unit 630 may control to transmit the message to direct the switching to the active mode to the femto base station. If the femto base station is in the active mode, the control unit 630 may not transmit the message directing the switching to the active mode.

Meanwhile, if all the registered terminals do not exist in the service coverage of the macro base station 600, the control unit 630 controls to transmit the message directing the switching to the sleep mode to the femto base station.

As another exemplary embodiment, the control unit 630 may transmit the message directing mode switching depending on the operation mode of the femto base station. For example, the control unit 630 determines whether or not all the registered terminals exist in the service coverage of the macro base station 600 by using the information received from the position comparison unit 620. On the basis of the determination result, when all the registered terminals do not exist in the service coverage of the macro base station 600, the control unit 630 verifies the operation mode of the femto base station and on the basis of the verification result, when the femto base station operates in the active mode, the control unit 630 may control to transmit the message directing the switching to the sleep mode to the femto base station. If the femto base station is in the sleep mode, the control unit 630 may not transmit the message to direct the switching to the sleep mode.

The transmission unit 640 converts a message or transmitted data depending on the control of the controller 630 into a format for transmission through wireless resources and transmits the corresponding message or transmitted data to the femto base station.

The reception unit 650 restores data from signals received from the femto base station or the terminals and transfers the restored data to the control unit 630. For example, the reception unit 650 provides the initial access request message received from the femto base station or the positional information received from the terminals to the control unit 630.

The memory unit 660 stores the positional information of the femto base station included in the received initial access request message and the list information of the terminals registered in the femto base station in accordance with the control of the control unit 630.

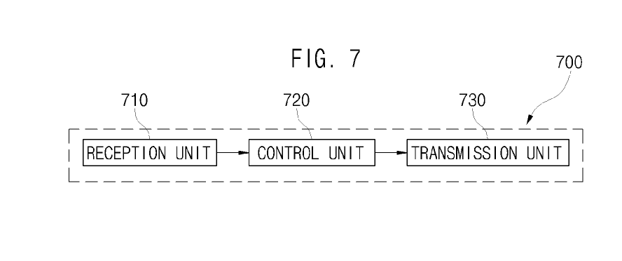

Referring to FIG. 7, the femto base station according to yet another exemplary embodiment of the present invention will be described. FIG. 7 is a block diagram illustrating a configuration of a femto base station according to yet another exemplary embodiment of the present invention.

Referring to FIG. 7, the femto base station 700 according to yet another exemplary embodiment of the present invention includes a reception unit 710, a control unit 720, and a transmission unit 730.

The reception unit 710 receives operation mode switching direction information from the macro base station through wireless communication.

The control unit 720 registers the terminals registered in the femto base station, and receives a direction of switching to the sleep mode when all the registered terminals do not exist in the service coverage of the macro base station to control the switching to the sleep mode or receives a direction of switching to the active mode transmitted when at least one of the terminals registered in the service coverage of the macro base station exists to control the switching to the active mode.

When the transmission unit 730 receives the operation mode switching direction information, the transmission unit 730 transmits a replay message to the macro base station.

According to the exemplary embodiments of the present invention, when an accessible terminal does not exist in a femto cell of a femto base station operating as a CSG cell in a wireless communication system, the femto base station is transitioned to a sleep mode through an X2 interface with a macro base station to which the femto base station belongs and the femto base station which operates in the sleep mode is transitioned to an active mode by controlling the macro base station so as to save power of the femto base station and reduce an amount of interference that occurs due to the operation of the femto base station.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of controlling a femto base station, comprising:
determining whether or not terminals registered in the femto base station exist in a service coverage of a macro base station to which the femto base station belongs;
verifying an operation mode of the femto base station if all the registered terminals do not exist in the service coverage on the basis of the determination result; and
directing the switching to a sleep mode to the femto base station when the femto base station operates in an active mode on the basis of the verification result.

2. The method of claim 1, wherein the macro base station and the femto base station are connected through an X2 interface, and
the femto base station operates a closed subscriber group (CSG) cell and only a terminal which is accepted to access is accessible.

3. The method of claim 1, wherein the verifying includes outputting a control signal for directing the verification of the operation mode of the femto base station if the terminal which accesses the macro base station does not exist within a predetermined reference time.

4. The method of claim 1, wherein the determining includes verifying whether or not the terminals exist in the service coverage by comparing the inputted service coverage of the macro base station with positional information of the terminals acquired from the terminals.

5. The method of claim 1, further comprising receiving and storing list information including identifiers of the terminals registered in the femto base station from the femto base station.

6. The method of claim 5, wherein the determining includes:
receiving an access verification message from the terminal which enters the service coverage; and
comparing the identifier stored in the macro base station with an identifier of the terminal included in the access verification message.

7. A method of controlling a femto base station, comprising:
determining whether or not terminals registered in the femto base station exist in a service coverage of a macro base station to which the femto base station belongs;
verifying an operation mode of the femto base station if at least one terminal of the registered terminals exists in the service coverage on the basis of the determination result; and
directing the switching to an active mode to the femto base station when the femto base station operates in a sleep mode on the basis of the verification result.

8. The method of claim 7, wherein the macro base station and the femto base station are connected through an X2 interface, and
the femto base station operates a closed subscriber group (CSG) cell and only a terminal which is accepted to access is accessible.

9. The method of claim 7, wherein the verifying includes outputting a control signal for directing the verification of the operation mode of the femto base station if the terminal which accesses the macro base station does not exist within a predetermined reference time.

10. The method of claim 7, wherein the determining includes verifying whether or not the terminals exist in the service coverage by comparing the inputted service coverage of the macro base station with positional information of the terminals acquired from the terminals.

11. The method of claim 7, further comprising receiving and storing list information including identifiers of the terminals registered in the femto base station from the femto base station.

12. The method of claim 11, wherein the determining includes:
receiving an access verification message from the terminal which enters the service coverage; and
comparing the identifier stored in the macro base station with an identifier of the terminal included in the access verification message.

13. A macro base station, comprising:
a position verification unit verifying positions of terminals registered in a femto base station positioned in a macro cell;
a position comparison unit comparing a service coverage of the macro base station with the verified positions of the terminals; and
a control unit directing the switching of an operation mode of the femto base station in accordance with the comparison result.

14. The macro base station of claim 13, wherein the control unit directs the switching to an active mode to the femto base station when at least one terminal of the terminals exists in the service coverage of the macro base station.

15. The macro base station of claim 13, wherein the control unit directs the switching to a sleep mode to the femto base station when all the terminals do not exist in the service coverage of the macro base station.

16. The macro base station of claim 13, wherein the control unit verifies an operation mode of the femto base station when at least one terminal of the terminals exists in the service coverage of the macro base station, and directs the switching to the active mode to the femto base station when the femto base station operates in the sleep mode on the basis of the verification result.

17. The macro base station of claim 13, wherein the control unit verifies the operation mode of the femto base station when all the terminals do not exist in the service coverage of the macro base station and directs the switching to the sleep mode to the femto base station when the femto base station operates in the active mode on the basis of the verification result.

18. A femto base station, comprising:
a reception unit receiving operation mode switching direction information from a macro base station through wireless communication;
a control unit controlling the switching of an operation mode in accordance with the direction of the switching of the operation mode received through the reception unit; and
a transmission unit transmitting a reply message to the macro base station when the operation mode switching direction information is received.

19. The femto base station of claim 18, wherein the control unit registers terminals registered in the femto base station in the macro base station and controls the switching to a sleep mode by receiving a direction of switching to the sleep mode when all the registered terminals do not exist in the service coverage of the macro base station.

20. The femto base station of claim 18, wherein the control unit registers the terminals registered in the femto base station in the macro base station and controls the switching to an active mode by receiving a direction of switching to the active mode when at least one of the registered terminals exists in the service coverage of the macro base station.
